(19) United States
(12) Patent Application Publication
(10) Pub. No.: US 2003/0069756 A1
(43) Pub. Date: Apr. 10, 2003

(54) Emergency department management process

(76) Inventors: James C. Higginbotham, Bainbridge, GA (US); Ellisa A. Mathis, Waywass, GA (US)

Correspondence Address: J. WILEY HORTON, ESQUIRE, Pennington, Moore, Wilkinson, Bell & Dunbar, P.A., Post Office Box 10095, Tallahassee, FL, 32302-2095, US

(21) Appl. No.: 10/260,972

(22) Filed: Sep. 30, 2002

Related U.S. Application Data
(60) Provisional application No. 60/326,130, filed on Oct. 1, 2001.

(51) Int. Cl. G06F 17/60

(52) U.S. Cl. 705/2

(57) ABSTRACT

An integrated resource allocation and billing process for an emergency medicine facility with a flexibility to adapt to other healthcare/patient settings. A key element is the addition of a “mLINC.” The “mLINC” is a nurse who is responsible for the integration of the billing and patient management decisions in the emergency department. This individual would perform his or her duties contemporaneously with patient treatment. The person known as mLINC applies a set process (preferably automated using computer software) to maximize the provision of compensable services and significantly shorten the accounts receivable lag time for the emergency department.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention.

This invention relates to the field of emergency medicine and health care facility and patient management. More specifically, the invention comprises a process for increasing the efficiency of resource allocation in an emergency department setting. By achieving a more efficient allocation of resources, patient care is improved. Portions of the process, or the entire process, may also be applicable to other healthcare settings, such as general hospital management and independent physician offices, clinics, and other settings where patient care is arranged or provided.

2. Description of the Related Art.

Health care management today involves much more than patient care. The proliferation of state and federal programs designed to pay for indigent and semi-indigent health care has created significant bureaucracy. Not only must a health care provider furnish the appropriate medical services, it must also provide the proper documentation in order to get paid for these services. This fact means that numerous codes must be assigned to each service performed. State, federal, and local rules govern which coded services will be paid for and an assigned rate of compensation for each.

Traditionally, the provision of medical services and the complicated process required to generate the required billing documentation have been relatively segregated processes. This is particularly true in the context of emergency medicine, where the obvious time constraints often preclude adequate consideration of financial issues.

It is important to realize that the state, federal, and local agencies assigning compensation rates for different services do not do so arbitrarily; i.e., if a service is deemed non-compensable, this generally is because the service is ultimately deemed unnecessary to the provision of quality medical care, or the service may be bundled into another service which is compensable. Thus, if one develops the goal of providing compensable services while excluding non-compensable ones, this does not conflict with the goal of providing the best care for the patients.

Unfortunately, the chaotic nature of many emergency departments results in a significant percentage of non-compensable work being performed. If, as an example, a patient is admitted as an inpatient when the medical criteria would not support this action, the hospital will not get paid and finite bed space would be needlessly occupied.

The billing process for most emergency departments does not begin in earnest until after the treatment has concluded (either with the patient being discharged, transferred, or admitted). By this point it is impossible to correct erroneous categorizations for the patient (such as in-patient admissions vs. observations). It is also difficult to correct missing documentation for the procedures performed. These concerns can cause a significant lag in accounts receivable for the emergency department—since the bills are not transmitted until the errors are corrected. In other cases, the bills may be returned because of errors which are then corrected and rebilled.

Accordingly, the prior art processes for billing for emergency care are therefore limited in that:

1. They cannot aid the emergency department in maximizing compensable services or minimizing non-compensable services;

2. They cannot correct erroneous patient categorizations;

3. They fail to efficiently correct errors involving missing documentation;

4. They fail to resolve registration errors prior to patient departure;

5. They fail to link patients to appropriate financial resources; and

6. There is no current comprehensive, well-defined, and established manual or electronic process.

### BRIEF SUMMARY OF THE INVENTION

The present invention provides an emergency department with integrated clinical, financial, and documentation processes. A key element is the addition of a “mLINC.” The “mLINC” is a nurse who is responsible for the integration of the billing and patient management decisions in the emergency department. This individual would perform his or her duties contemporaneously with patient treatment. The mLINC applies a set process (preferably automated using computer software) to facilitate optimal documentation of services, thereby maximizing the provision of compensable services and significantly shortening the accounts receivable lag time in the emergency department and ultimately throughout the entire organization.

Another key element in the process disclosed is the addition of coding steps (preferably automated using computer software). The patient's nurse, at discharge, ensures complete and accurate documentation of the medical record. The emergency department coder (“ED coder”), who is trained in proper service coding, enters the appropriate codes. These steps ensure that a bill is ready for review by the patient before the patient actually leaves the facility, allowing the opportunity for immediate copayment and/or out-of-pocket collection attempts. Variations in the ability to complete (produce) a time-of-service bill depend on the managed information system used by the facility. Departmental charges do not always pass through until the end of the working day. Therefore, some charges will not immediately appear on a bill. In these cases, it may be beneficial to pre-code records and finalize the bills after a certain elapsed period (such as 72 hours).

### BRIEF DESCRIPTION OF THE SEVERAL VIEWS OF THE DRAWINGS

FIG. 1 is a block diagram showing the incorporation of the present process in the prior art room process.

FIG. 2 is a block diagram showing the details of the admission versus outpatient decisions by the mLINC.

FIG. 3 is a block diagram showing the details of the coding process.

FIG. 4 is a block diagram showing the details of the resource identification process.

FIG. 5 is a block diagram showing a simplified representation of the proposed process.

FIG. 6 is a block diagram showing a simplified representation of the proposed process.

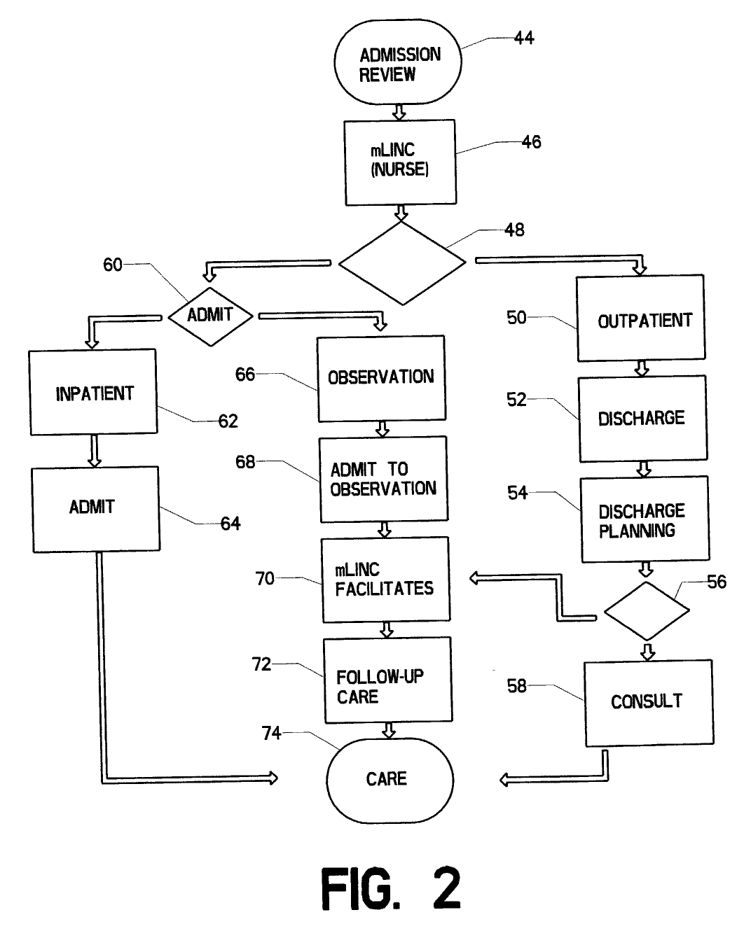

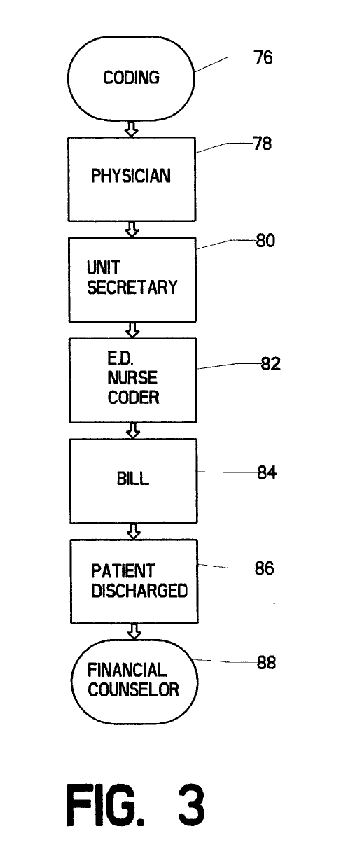

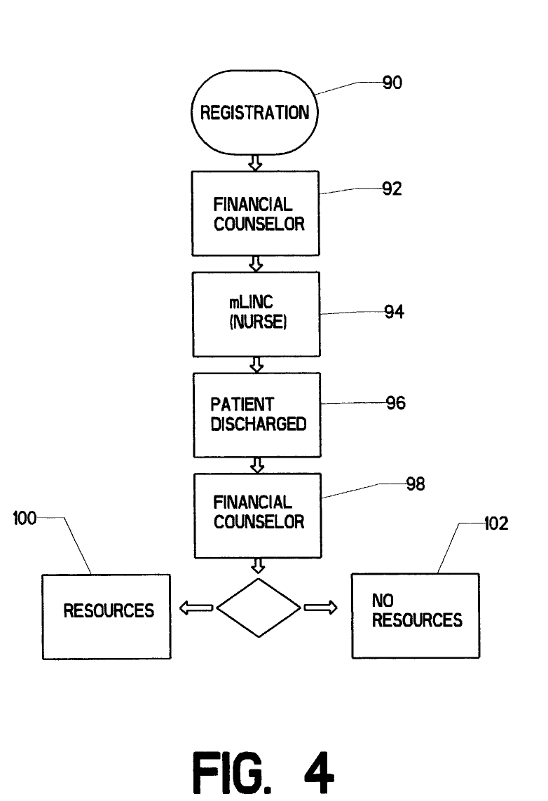

### REFERENCE NUMERALS IN THE DRAWINGS

| | | | |
|---|---|---|---|
| 10 | patient entry | 12 | triage |
| 14 | non-urgent category | 16 | triage decision |
| 18 | emergent/urgent category | 20 | medical screening exam |
| 22 | mLINC | 24 | jump to FIG. 2 |
| 26 | acuteness decision | 28 | acute category |
| 30 | non-acute category | 32 | CPT coding |
| 34 | jump to FIG. 3 | 36 | jump to FIG. 4 |
| 38 | indigent/non-indigent | | |
| | decision | | |
| 40 | indigent category | 42 | non-indigent category |
| 44 | admission review | 46 | mLINC (Nurse) |
| 48 | admit/outpatient decision | 50 | outpatient category |
| 52 | discharge step | 54 | discharge planning |
| 56 | outpatient/non-outpatient | | |
| | decision | | |
| 58 | consultation step | 60 | inpatient/observation decision |
| 62 | inpatient category | 64 | admission step |
| 66 | observation category | 68 | observation admission step |
| 72 | follow-up care | 74 | care |
| 76 | coding start | 78 | physician charting |
| 80 | ED coder coding step | 82 | nurse coding |
| 84 | bill generation | 86 | patient discharge |
| 88 | financial counseling step | 90 | patient registration |
| 92 | financial background | 98 | patient financial meeting |
| 100 | resource identification | 102 | patient education |
| 104 | DX-LINC application | 108 | Cover-LINC application |
| 110 | Info-LINC application | 112 | patient transported to room |
| 114 | Super-LINC | 116 | Core-Dynamics |

### DETAILED DESCRIPTION OF THE INVENTION

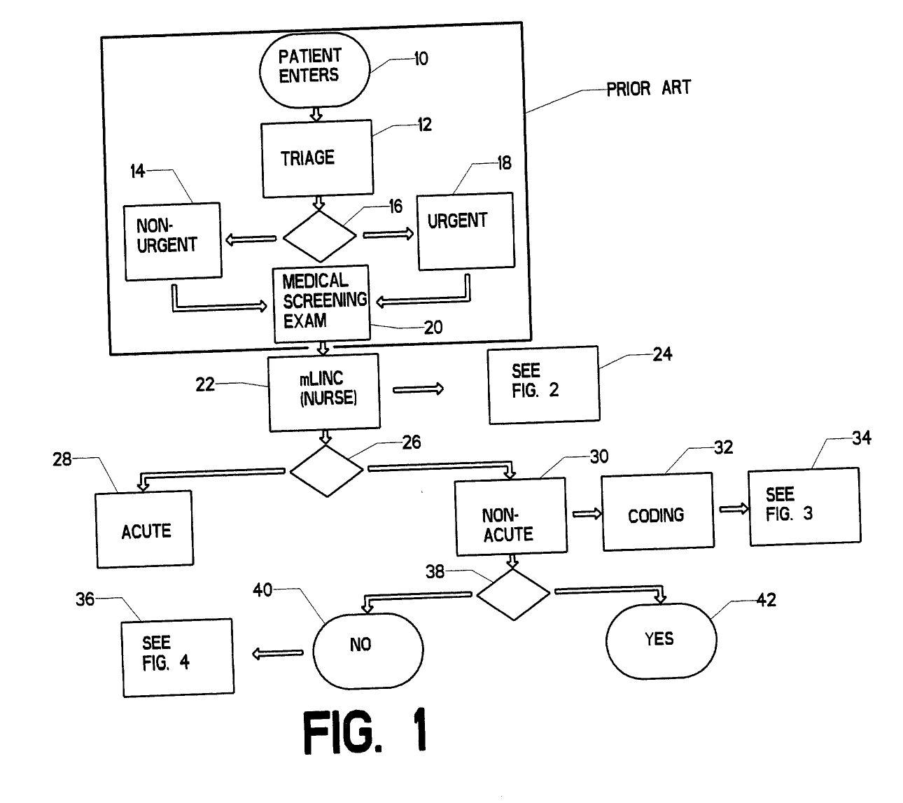

While those skilled in the art will be familiar with the typical emergency room process, a brief description may prove helpful. Turning now to FIG. 1, the process begins when a patient enters the emergency department—either via ambulatory or ambulance entrance. This step is denoted as patient emergency triage 12 is then typically performed by an admitting nurse. Triage 12—which typically consists of a rapid assessment—results in triage decision 16. Incoming patients are then split into emergent/urgent category 18 and non-urgent category 14.

Ensuring that there is no delay in performing the medical screening exam, patients within non-urgent category 14 are sent to patient registration. Personnel in patient registration obtain the patient's information, including home address, contact persons, and health insurance particulars. Patients within emergent/urgent category 18 undergo treatment immediately. The registration process is then typically conducted with family members—if present. Otherwise, completion of the registration process is postponed.

Both initial categories of patients undergo a medical screening exam 20. A more thorough examination is conducted at this point (as compared to triage 12) in an attempt to identify the source of the patient's condition. All of the steps described up to this point are commonly performed, with some variations, in emergency departments throughout the United States. With the exception of the registration portions, all of the prior steps involve trained medical personnel (All these steps are within the box labeled “prior art” in FIG. 1).

The present invention adds a nurse coordinator, whom the inventors have elected to designate as mLINC 22. The person acting as mLINC 22 would typically be a registered nurse. His or her role is performed while the medical treatment is ongoing, but this role is more in the nature of resource allocation and optimization of services. The reader will note that during patient treatment, MLINC 22 performs an initial review of the patient's chief complaint, the present diagnosis (as determined by the medical provider actually providing care), the result of the physical examination, and the diagnostic work-up (such as blood tests, etc.). Review of data by MLINC 22 can be enhanced through the use of computer software, which shall be referred to as “DX-LINC”. The review can ensure that appropriate documentation supporting the medical necessity of any diagnostic tests ordered is present.

The DX-LINC software has the following objectives: (1) Link diagnostic tests ordered by the care providers to appropriate medical documentation or diagnoses; (2) Decrease non-compensable services; and (3) Provide notification so that necessary pre-certifications are obtained (a “pre-certification” is a set of findings that must be made before a certain procedure may be ordered). The software would ideally: (1) Interface with the hospital system's main computer programs regarding patient data, etc.; (2) Employ a complete electronic record, including physician and nursing notes; (3) Evaluate the documentation on hand against the established criteria of medical necessity for ordered tests; (4) Provide an alert when additional criteria need to be met before ordering the test; and (5) Provide management reports for trending, tracking, and key statistics. Although the use of electronic records is preferable, the software would also be able to operate as a stand-alone module with an operator manually entering data from paper records, etc.

Still referring to FIG. 1, mLINC 22 compares the information gathered against criteria provided/mandated by any payor source (such as the federal Centers for Medicare and Medicaid Services, hereinafter “CMS”). These criteria are at present commonly referred to by the name “Interqual.” As one example, those skilled in the art will know that CMS currently provides detailed criteria for deciding when a patient needs critical care services. CMS criteria are very important, since they ultimately determine whether the services rendered are compensable. The application of the CMS criteria, or any other payor specified criteria, to mLINC 22's decisions can be substantially automated through the use of a computer program. The inventors refer to this computer program as “Info-LINC.”

The Info-LINC software has the following objectives: (1) Link diagnostic data and patient-specific data to all mandated approved criteria (such as CMS criteria) for reimbursement (such as admit for treatment vs. admit for observation ); (2) Provide a continual review of data as it is entered or obtained; (3) Notify the care providers when to appropriately change patient status from observation to inpatient, observation to outpatient, inpatient to outpatient, or critical care to acute care; and (4) Provide a mechanism for providing post-care follow-up. The software would ideally: (1) Interface with the hospital system's main computer programs regarding patient data, etc.; (2) Employ a complete electronic record, including physician and nursing notes; (3) Evaluate the documentation on hand against the established criteria mandated by payor; and (4) Provide management reports for trending, tracking, and key statistics. Like the DX-LINC software, the Info-LINC software would also be able to operate as a stand-alone module with an operator manually entering data from paper records, etc.

The admission decisions performed by mLINC 22 should be understood in detail. An admission review is customarily conducted by mLINC 22 (in order to determine whether a patient will be admitted to the hospital or treated as an outpatient). Referring to FIG. 1, the reader will note that mLINC 22 first sees the patient after the completion of medical screening exam 20. Medical treatment does not stop at this point. It is proceeding in parallel. During the treatment, mLINC 22 performs an initial review of the patient's chief complaint, the present diagnosis (as determined by the persons actually providing care), the results of the physical examination, and the diagnostic work-up (such as blood tests, etc.).

mLINC 22 compares the information gathered against all mandated payor criteria, which are currently provided by CMS. FIG. 1 shows a step labeled as jump to FIG. 2 24. Turning now to FIG. 2, the inpatient admission decisions performed by mLINC 22 will be explained. Admission review 44 is customarily conducted by mLINC 22. After mLINC 22 has gathered the information described in the preceding paragraphs and applied the CMS criteria (possibly using the proposed software, Info-LINC), admit/outpatient decision 48 is reached. Broadly, the CMS criteria will indicate that the patient must either be admitted or treated as an outpatient. Assuming that admission is indicated, the next step would be inpatient/observation decision 60.

If the CMS criteria indicate that inpatient admission of the patient to the hospital is warranted, then the patient proceeds to inpatient category 62. The patient would then be processed into a regular hospital room (or intensive care unit, etc.), shown as admission step 64. A course of care 74 is then provided in the hospital.

If the CMS criteria indicate that the patient does not meet inpatient admission criteria, yet needs to be monitored, the patient would be placed in observation category 66. The patient would then be admitted through observation admission step 68. During observation, the patient is closely monitored with clinical and diagnostic findings being screened against CMS criteria. At the appropriate time, based on patient condition and criteria, the patient is either admitted to inpatient category 62 or discharged as an outpatient (discharge step 52). mLINC 22 then becomes involved in the planning of outpatient care (if ultimately warranted), shown in the figure as follow-up care 72. mLINC 22 also assists with discharge planning 54 and education of the patient regarding community resources and referrals (such as substance abuse treatment centers, elder care center, follow-up care 72, etc.). The patient then proceeds to follow up care 72, which would be conducted via telephone for patients seen after hours. The patients would ultimately then receive care 74 on an outpatient basis.

Assuming that the result of admit/outpatient decision 48 is that the patient may be safely treated as an outpatient, then the patient is placed in outpatient category 50. These patients receive generally brief treatment, and then progress to discharge step 52. Discharge planning 54 seeks to ensure appropriate follow-up care 72. If the patient has an attending physician, this physician would, as necessary, be contacted at this point (usually by telephone). mLINC 22 would again become involved in the planning of outpatient care 74 (if ultimately warranted). mLINC 22 would also assist with discharge planning 54 and education of the patient regarding community resources and referrals.

The attending physician is contacted at the point of each admission decision and, as appropriate, for outpatient decisions. If a conflict should arise between the attending and Emergency Department physicians'decisions, the Emergency Department physician, attending physician, and mLINC would collaborate in order to determine the appropriate level of care 74.

Returning now to FIG. 1, the reader will note that after mLINC 22 has initially become involved, the patient reaches an acuteness decision, which is determined by the medical provider (see FIG. 1, acuteness decision 26). Patients in the acute 28 category are either admitted to the attached hospital or transferred to another hospital (in the case of special injuries requiring a special treatment center). Patients in the non-acute category 30 proceed toward discharge 86.

Using the inventors'coding and billing process (preferably automated through a third piece of software known as Super-LINC, which recognizes a patient's payor source and assigns payor-specific coding guidelines), medical record documentation completeness is ensured and the appropriate codes are assigned—including professional and facility CPT 32 and ICD-9 codes and modifiers. One of the main goals of the efficient coding process described is to produce a clean claim for billing purposes and generate a statement for the patient's review prior to departure from the facility. The other main goal is to reduce accounts receivable lag. As mentioned previously, it may be helpful in some cases to re-code records and finalize them after a certain time frame has elapsed.

Referring now to FIG. 3, the first substantive step in the coding process is physician documentation (listed as physician charting 78). In this step the physician providing patient care 74 records information to include assessment findings and services provided based on clinical need. The medical records are reviewed to ensure complete physician and nurse documentation. The completed records then go to the ED coder who, based upon documentation, assigns the appropriate codes, including professional and facility CPT and ICD-9 codes and modifiers, shown in the figure as ED coder coding step 82. Bill generation is the next step, where a complete listing of services and supplies provided is generated (bill generation 84). After medical record coding, patients in the non-acute category 30 proceed toward discharge 86 and are directed to the financial counselor, in the financial counseling step 88. For future reference, alternate care 74 settings for non-acute 30 (non-emergent) conditions are discussed with these patients.

All discharged patients then proceed to meet with a financial counselor. This is denoted in FIG. 1 as jump to FIG. 4 36. FIG. 4 details the billing process from the patient's perspective. The process begins with registration 90 (which—as previously explained—occurs when the patient first comes into the emergency department). The information collected at registration 90 is forwarded to a financial counselor. The financial counselor then verifies the insurance information, obtains information regarding co-payments and deductibles, obtains information regarding the patient's past account balances, and prepares a financial agreement form. All these operations are carried out in the step labeled financial counselor 92. The financial counselor is performing this work while the patient is still being treated (i.e., well prior to discharge 86).

When a patient is approaching discharge 86 (in FIG. 3), mLINC 22 notifies the financial counselor. During this same period, mLINC 22 coordinates with the various physicians to ensure staggered discharge of patients 54 so that the financial counselor is not overwhelmed. Once an appropriate schedule is created, a particular patient progresses to discharge step 52. Following discharge 86, the patient is sent to meet with the financial counselor, shown as step 98 in FIG. 4. At this meeting the financial counselor—having obtained the patient's financial background—discusses payment options. The financial counselor will ideally employ a fourth piece of computer software, which the inventors refer to as Cover-LINC. This software links patients to the appropriate financial resources. The Financial Counselor also discusses healthcare coverage and payment options (including bank financing). Co-payments and deductibles are collected from the patient at this point, if appropriate. Full payment, payor matches, and/or payment arrangements are made with self-pay patients. For patients admitted to the hospital under inpatient or observation status 66, a financial counselor will provide financial follow-up in the same manner on the next business day.

Portions of the financial counseling steps are preferably automated through the use of the Cover-LINC software. It has the following objectives: (1) Link patients with the appropriate charity, community service, and/or state and federal assistance programs; (2) Handle financial arrangements for patients having the ability to pay (such as a payment plan over time); and (3) Link the patient to banking and financing options per the facility or patient choice.

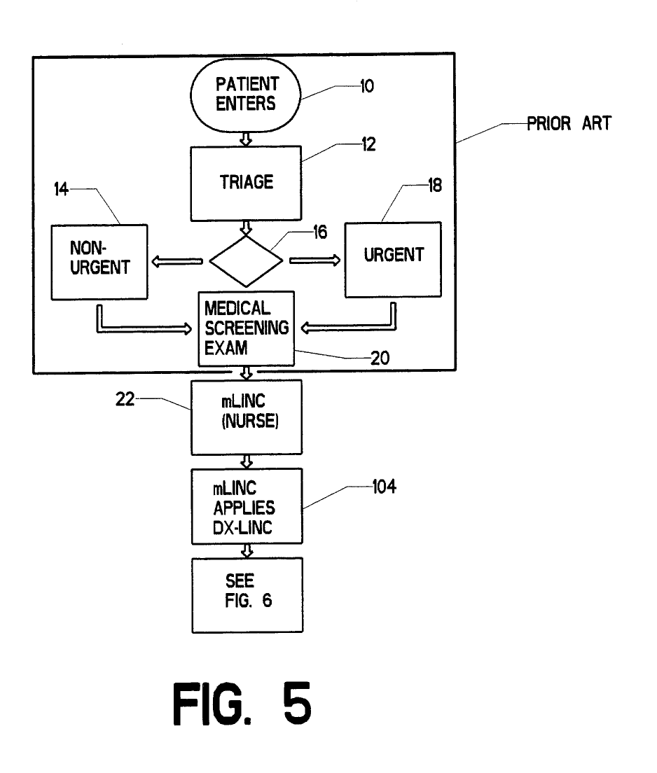

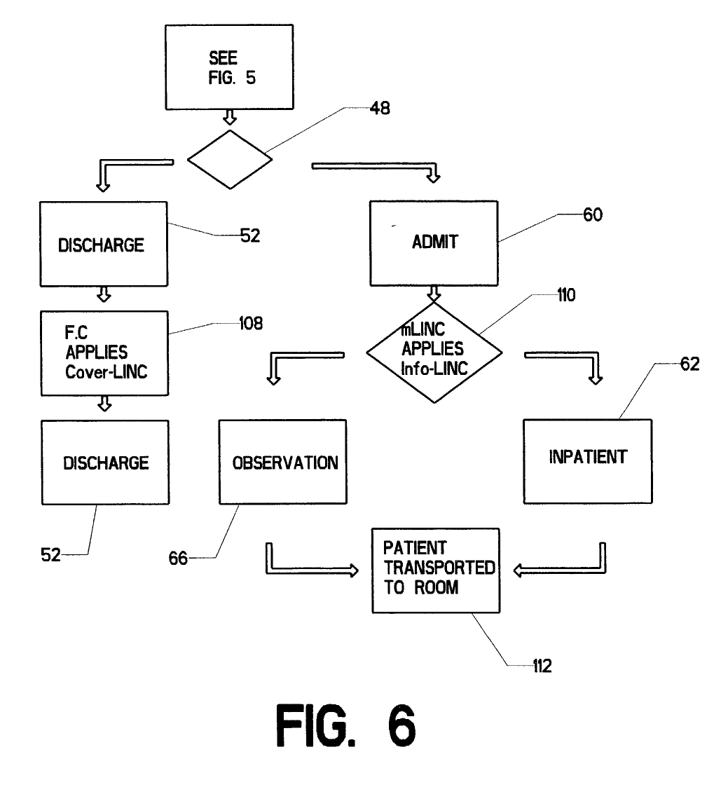

FIG. 5 depicts a simplified representation of the entire process, including the application of the software described. The reader will note that the upper portion of the process depicted in FIG. 5 (the prior art portion), is identical to that shown in FIG. 1. After medical screening exam 20, mLINC 22 becomes involved. At this point, mLINC 22 applies the software known as DX-LINC (described previously) to verify that all steps are properly in place regarding the diagnostic procedures. The process then continues to FIG. 6, as indicated. The next step is admit/outpatient decision 48. If the patient does not need to be retained, then the patient moves to discharge step 52. The patient then meets with the Financial Counselor. At that point, the Financial Counselor applies the software known as Cover-LINC (step 108, described previously) to find sources of payment. The coding process (preferably automated by the software known as Super-LINC)—by this time completed—feeds data to the Financial Counselor regarding what services have been performed. The patient then moves to discharge 86. The patient then meets with the Financial Counselor.

If, on the other hand, the outcome of admit/outpatient decision 48 is that the patient needs to be retained, then the process moves to Info-LINC application 110. As described previously, the application of this software ensures that the proper criteria for observation 66 versus inpatient admission is observed. Depending on the outcome of the software's application, the patient either goes to observation 66 or inpatient care 62. The patient is then transported to a room, as denoted by step 112.

The disclosed process and proposed software programs, with adaptation, would be applicable to any patient care setting. This process is augmented by the proposed software programs. However, it should be noted that all parts of the process could be successfully implemented without computers and software. Furthermore, the success of the process is not dependent upon the employee position titles as named.

It is the inventors' intent that the present invention eventually include the development of a full suite of computer software which can be used as stand alone modules or which can be integrated to create a fully electronic patient record. This record would ideally include physician, nursing, and ancillary staff notes (referred to by the inventors as “CORE-DYNAMICS”). Also, it is the intent to make these software modules adaptable to any patient care setting, other software programs, and management information systems. It should be noted that the process can be successful manually.

Through the disclosed process, it is the inventors' intent to establish standard national criteria to evaluate the performance of Emergency Departments and other health care providers to include the following areas: documentation, billing, collection, special services, financial, coding, and payor reimbursement. The performance outcome indicators will periodically be compiled aggregately to provide national benchmark scores. This information will be used as an ongoing evaluation of the process in order to implement changes necessary to optimize outcomes.

Accordingly, the reader will appreciate that the proposed invention provides a more efficient process for the integration of clinical and financial and documentation management processes in the emergency medical department. In addition, it is recognized that parts or the whole of these processes, including the embedded automation provided by the computer programs, would be beneficial in multiple patient care settings. The invention has specific advantages, via the use of computer software or a manual process, in that it:

1. Maximizes compensable services and minimizes non-compensable services;

2. Prevents erroneous patient categorizations;

3. Prevents errors involving missing documentation (with the added benefit of reduced medical-legal risk);

4. Allows for correction of registration information prior to patient discharge;

5. Allows for concurrent coding in the emergency department setting;

6. Links patients to appropriate financial resources;

7. Prevents inappropriate allocation of resources which increase health care/hospital costs; and

8. Provides for a time of service bill, which decreases accounts receivable lag, thereby increasing cash flow to hospitals/organizations.

Although the preceding description contains significant detail, it should not be construed as limiting the scope of the invention but rather as providing illustrations of the preferred embodiment of the invention.

Having described our invention, we claim:

1. A method for providing optimal documentation of services provided in a health care facility, comprising:
a. performing an initial screening exam in order to gather data concerning a patient's medical condition;
b. having a nurse coordinator review the results of said initial exam in order to determine the following data:
i. said patient's chief complaint;
ii. the present diagnosis as provided by the medical providers working with said patient;
iii. the physical findings; and
iv. the results of any diagnostic tests performed;
c. having said nurse coordinator compare said data concerning said patient's medical condition against standard payor-supplied criteria, while said patient is receiving medical treatment; and
d. once said medical providers have made a decision to admit said patient to said healthcare facility, having said nurse coordinator use said payor-supplied criteria to determine whether to admit said patient as an inpatient or hold said patient for observation.

2. A method as recited in claim 1, wherein steps (c), and (d) are automated through the use of a computer program.

3. A method as recited in claim 1, further comprising having said nurse coordinator use said payor-supplied criteria to determine what documentation must be created in order to demonstrate the medical necessity of the treatment provided to said patient, while said treatment is being provided.

4. A method as recited in claim 3, further comprising having said nurse coordinator collect said documentation.

5. A method as recited in claim 3, further comprising assigning appropriate codes to all treatment of said patient.

6. A method as recited in claim 5, further comprising:
a. generating a bill for all treatment of said patient which lists all services provided and all medical supplies provided;
b. matching said patient with available sources for payment of said bill; and
c. discharging said patient.

7. A method as recited in claim 3, wherein a computer program is employed.

8. A method as recited in claim 4, wherein a computer program is employed.

9. A method as recited in claim 5, wherein a computer program is employed.

10. A method as recited in claim 6, wherein a computer program is employed.
